(19) United States
(12) Patent Application Publication
(10) Pub. No.: US 2013/0032369 A1
(43) Pub. Date: Feb. 7, 2013

(54) Method and device for position determination of an object with light source through cameras with optical band-pass filter or light sensors with optical band-pass filter

(71) Applicant: Jakob Dridger, Hessheim (DE)

(72) Inventor: Jakob Dridger, Hessheim (DE)

(21) Appl. No.: 13/197,801

(22) Filed: Aug. 4, 2011

(51) Int. Cl. B25B 21/00; H04N 7/18

(52) U.S. Cl. 173/2; 348/135; 348/E07.085

(57) ABSTRACT

A method and device for determining the position of the object with a light source. The light source illuminates light with a specific range of wave length. The optical band-pass filter lets pass only the light from the light source for the most part. And the camera only sees the light from the light source which is mounted on the object. The arithmetic unit calculates the position of the light source from the data of the cameras. The position is known of the light source on the object and therefore it is possible to determine the position of the object over the position of the light source.

### BACKGROUND OF THE INVENTION

The invention relates to a method and device for determine the position of an object. The exact determining the position of objects in the industrial production is a vary useful and necessary condition. The acknowledgment the coordinates of the tools and components provide increasing quality of products and decreasing production costs. For example at tightening joint screws of cylinder head must follow the right sequence to avoid stress in the cylinder head and clamp the cylinder head seal uniformly. A screw joint which has not been acceptably tightened can cause a break down of safety critical parts of a motor car.

At the moment there are several possibilities to determine the position of an object:

Mechanical, for example through turn sensors or distance sensors. The object is mounted on a movable arm. The Disadvantage of this system is that a movable arm is fixed on a device and the freedom of movement is limited.

Position determination through delay time, for example Global Positioning System or ultrasound. The disadvantage of a system based on radiowave is bad accuracy (circa 50 cm) and therefore is not sufficient. A ultrasound positioning system is disturbed by sound of pneumatic machines that are used in a production.

Position determination through a optical method with a camera. The camera searches for a pattern or an object that is deposited in the memory of the system.

This system is very disturbed for example by bad contrast, bad lightening and radiation of other light sources.

It is an object of the invention to provide a method and device for determining the position of an object precise and undisturbed. It increase the quality on objects assembled by screw joints through force the operator for removal an unacceptable tightened screw joint before he move to the next screw joint or object.

Further objects and advantages of the invention will appear from the following specifications and claims.

A preferred embodiment of the invention is described below with references to the accompanying drawings.

### BRIEF DESCRIPTION OF THE DRAWINGS

FIG. 1 shows a schematic view of an object with a light source which position will determine through a light sensor/image sensor with an optical band-pass filter and an optical lens.

FIG. 2 shows a schematic 3D plane view of an object with a light source and the light sensor/image sensor, the optical band-pass filter and the optical lens are shown as a plane.

FIG. 3 shows a similar view as FIG. 2 but illustrates two systems comprises light sensor/image sensor, optical band-pass filter and optical lens as a plane for determining the position of the object in space.

FIG. 4 shows a schematic view of a workpiece carrier carrying an object with screw joints to be tightened by a power wrench with position indicating means.

### DETAILED DESCRIPTION

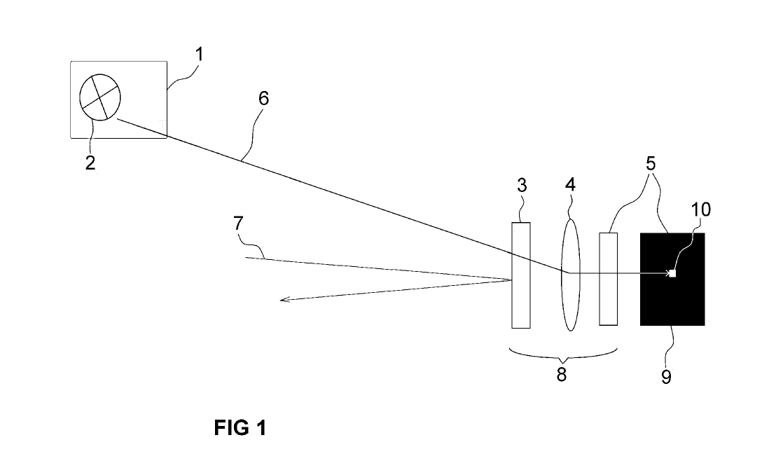

The schematic arrangement shown in FIG. 1 comprises an object 1 with a light source 2, an optical band-pass filter 3, an optical lens 4, a light sensor/image sensor 5, a front view of the light sensor/image sensor 9, a pixel 10 on the light sensor/image sensor, a light beam 6 from the light source and a light beam 7 from other light source that is unwanted. Number 8 shows the side view of the optical band-pass filter 3, optical lens 4 and the light sensor/image sensor 5.

The arrangement in FIG. 1 describes the method of the invention for sense the light from the light source 2 to determine the position of the object 1. The light beam 6 from the object 1 passes the optical band-pass filter 3, the optical lens 4 and meets the light sensor/image sensor 9. The pixel 10 that is illuminated from the light beam 6 appear as a bright pixel. All pixels that are illuminated from the light beam 6 together add up to a bright flaw. The unwanted light beam 7 can not pass the optical band-pass filter and therefore comes the bright flaw 10 on the light sensor/image sensor only from the light source 2 from the object 1. The bandwidth of the light source 2 and the bandwidth of the optical band-pass filter 3 is attuned to each other.

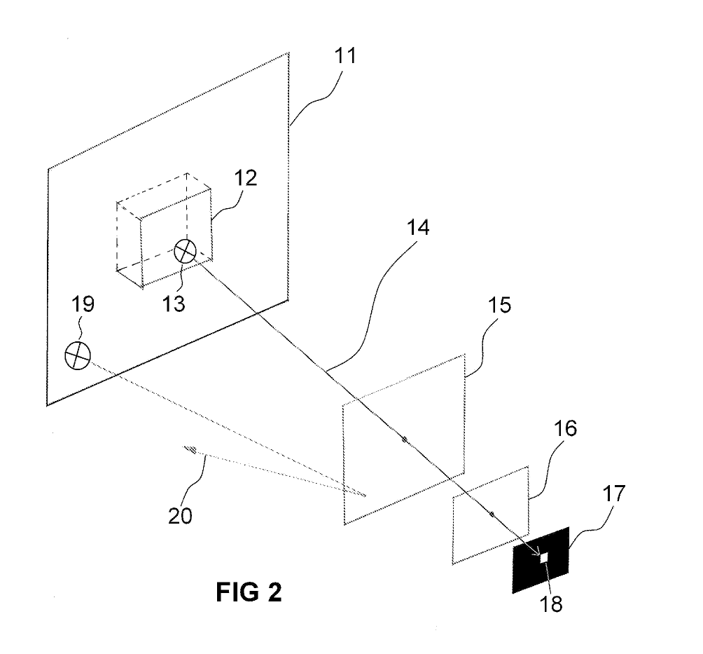

In FIG. 2 there is illustrated the schematic arrangement in form of planes.

The arrangement in FIG. 2 comprises an object 12 with a light source 13, a plane 11 of the object 12, an optical band-pass filter 15, an optical lens 16, a light sensor/image sensor 17, a pixel 18 on the light sensor/image sensor 17, a light beam 14 from the light source 13 and a light beam 20 from other light source 19 that is unwanted.

The arrangement in FIG. 2 describes the method of the invention for sense the light from the light source 13 to determine the position of the object 12. The light beam 14 from the light source 13 passes the optical band-pass filter 15, the optical lens 16 and meets the light sensor/image sensor 17. The pixel 18 that is illuminated from the light beam 14 appear as a bright pixel. All pixels that are illuminated from the light beam 14 together add up to a bright flaw. The unwanted light beam 20 can not pass the optical band-pass filter 15 and therefore comes the bright flaw on the light sensor/image sensor 17 only from the light source 13 on the object 12. The bandwidth of the light source 13 and the bandwidth of the optical band-pass filter 15 is attuned to each other.

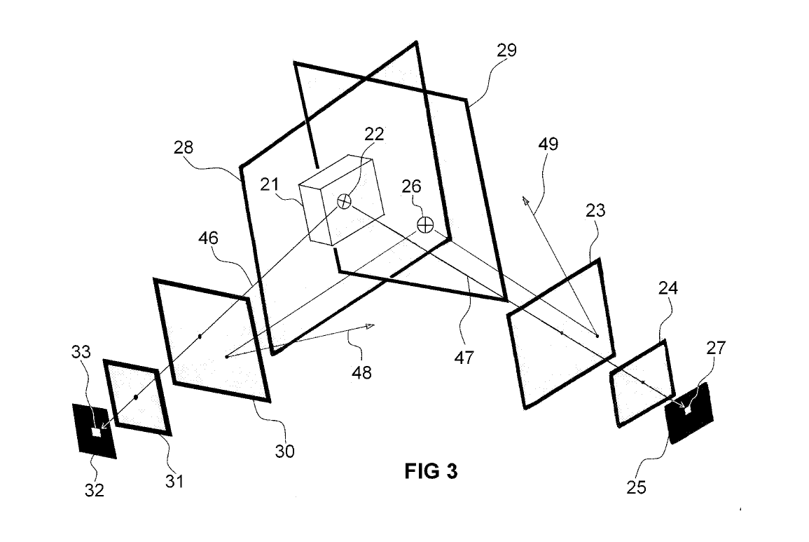

In FIG. 3 there is illustrated the schematic arrangement in form of planes which comprises two systems for determine the position of an object in space.

The schematic arrangement comprises an object 21 with a light source 22, two planes from two views 28, 29 of the object 21, an optical band-pass filter 23, 30, an optical lens 24, 31, a light sensor/image sensor 25, 32, a pixel 27, 33 on the light sensor/image sensor 25, 32, a light beam 46, 47 from the light source 22 and a light beam 48, 49 from other unwanted light source 26.

The arrangement in FIG. 3 describes the method of the invention for sense the light from the light source 22 to determine the position of the object 21 in space. The light beam 46, 47 from the light source 22 passes the optical band-pass filter 23, 30, the optical lens 24, 31 and meets the light sensor/image sensor 25, 32. The pixel 27, 33 that is illuminated from the light beam 46, 47 appear as a bright pixel. All pixels that are illuminate from the light beam 46, 47 together add up to a bright flaw. The unwanted light beam 48,49 can not pass the optical band-pass filter 23, 30 and therefore comes the bright flaw on the light sensor/image sensor 25, 32 only from the light source 22 on the object 21. The bandwidth of the light source 22 and the bandwidth of the optical band-pass filter 23, 30 is attuned to each other. Under consideration of geometrical context it is possible from the information of the light sensor/image sensor 25, 32 to determine/calculate the position of the object 21 in space.

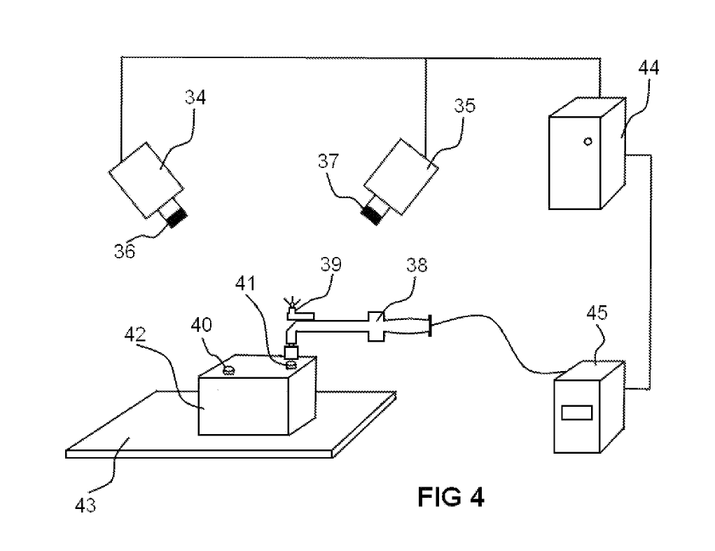

In FIG. 4 there is illustrated an embodiment of the invention that provides a device to control a power wrench 38 that each screw joint 40,41 is tightened with the right parameters. The power wrench 38 is provided with an identity providing means in the form of a light source 39 which is recognised by two stationary position scanning cameras 34, 35 with optical band-pass filter 36, 37, wherein the light source 39, the cameras 34,35, the optical band-pass filters 36, 37 and control unit/calculation unit 44 form a position sensing system. The cameras 34,35 with the optical band-pass filter 36,37 are connected to the control unit/calculation unit 44 and arranged to transfer the signals for calculation the actual position of the power wrench 38. The control unit/calculation unit 44 is connected to the control unit 45 of the power wrench 38 and they communicate with each other.

The position sensing system is arranged to indicate continuously the position of the power wrench 38 during operations on the workpiece 42 that lies on the workpiece carrier 43.

The control unit 45 of the power wrench 38 is programmed with target torque levels, angle and/or spend time as well as limit value for each tightening operation for each screw joint 40, 41. The control unit/calculation unit 44 is programmed with the right sequence of tightening screw joints 40, 41. That means that each tightening operation will monitor by the control unit 45 and control unit/calculation unit 44 and they together will provide an OK or NOK indicating telling whether the tightening result of each screw joints 40,41 is acceptable or not.

If a non-acceptable tightening result is occurred it is possible to program the control unit 45 of the power wrench 38 so, that for example the power wrench 38 can be locked until the non-acceptable tightening screw joint is corrected before moving to the next screw joint or to the next workpiece. Other possibilities for programming the control unit 45 are thinkable and are not limited after a non-acceptable tightening screw joint.

An important advantage provided by the method and device according to the invention is that no-preprogramming of screw joint positions is necessary.

It is to be observed that the embodiment of the invention are not limited to the above described examples but may be freely varied within the scope of the claims. For instance, the above mentioned method to communicate signals by wire between the control unit of the power wrench and the control unit/calculation unit of the position sensing system may be carried out by any available communication system and by wireless communication too. All communications by wire can replace through wireless communications. The control unit of the power wrench and the control unit/calculation unit of the position sensing system can be integrated to one control unit.

1. Method for determining the position of a object (1;12;21) with light source (2;13;22) through a light sensor/image sensor (5;17;25;32) with optical band-pass filter (3;15;23;30), comprising the steps of: providing a light sensor/image sensor (5;17;25;32), an optical band-pass filter (3;15;23;30) set in front of a light sensor/image sensor (5;17;25;32), an object (1;12;21) with a light source (2;13;22) and an arithmetic unit for calculation the position of the object (1;12;21); the light source (2;13;22) on the object (1;12;21) that illuminates light with a specific range of wave length, the optical band-pass filter (3;15;23;30) let pass only the light from the light source for the most part, therefore the light sensor/image sensor (5;17;25;32) detect for the most part the light from the light source (2;13;22) of the object (1;12;21), the arithmetic unit calculate the position of the light source (2;13;22), the position of the light source (2;13;22) on the object (1;12;21) is known and out of it the arithmetic unit determine the position of the object (1;12;21).

2. Method according to claim 1, wherein said light source (39) comprises a light emitting semiconductor component or a light emitting diode LED.

3. Method according to claim 1, further comprising: one or more cameras with optical band-pass filter, or one or more light sensors/image sensors with optical band-pass filter, one or more light sources on the object, a arithmetic unit for determining the position of the object over the light source from the data of cameras or light sensors/image sensors.

4. Method according to claim 1, wherein the geometrical arrangement of the cameras or light sensors/image sensors is form so that it make possible a precision determining the position and the orientation of the object.

5. Method according to claim 1, wherein the mount of multiple light sources on the object that it make possible a precision determining the orientation of the object.

6. Method according to claim 1, wherein the bandwidth of the light source (2; 13; 22) and the bandwidth of the optical band-pass filter (3; 15; 23; 30) is attuned to each other.

7. Control device for a power wrench (38) to monitor the sequence of tightening screw joints (40;41) and to control that each screw joint (40; 41) tighten with the right parameters, comprising: a position sensing system (34-37; 39) which method is described in claims 1 to 9 is applied to indicate continuously the actual position of the power wrench (38) during tightening of screw joints (40; 41) on the component (42) to be assembled; a arithmetic unit/control unit (44) of the position sensing system (34-37; 39) for calculate the position of the power wrench (38) and for control the tightening of the screw joints (40; 41), the arithmetic unit/control unit (44) communicate with the control unit (45) of the power wrench (38) to monitor the position of the power wrench (38) and to monitor the tightening of the screw joints (40; 41); said control units (44; 45) indicate an OK (o.k.) for each acceptable tightened screw joint and indicate a NOK (not o.k.) for unacceptable tightening screw joint.

8. Control device according to claim 7, wherein the said position sensing system comprises one or more light sources (39) located on the power wrench (38), and one or more cameras (34; 35) with optical band-pass filters (36; 37) connected to the arithmetic unit/control unit (44) and arranged to communicate with said control unit (45) of the power wrench (38).

9. Control device according to claim 7, wherein said light source (39) comprises a light emitting semiconductor component or a light emitting diode LED.
